(19) United States
(12) Patent Application Publication
(10) Pub. No.: US 2003/0171217 A1
(43) Pub. Date: Sep. 11, 2003

(54) Support, its production method and catalyst body

(76) Inventors: Kazuhiko Koike, Okazaki-City (JP); Masakazu Tanaka, Okazaki-City (JP); Tomohiko Nakanishi, Kariya-City (JP); Jun Hasegawa, Hekinan-City (JP)

Correspondence Address: NIXON & VANDERHYE, PC, 1100 N GLEBE ROAD, 8TH FLOOR, ARLINGTON, VA, 22201-4714, US

(21) Appl. No.: 10/376,315

(22) Filed: Mar. 3, 2003

(30) Foreign Application Priority Data
Mar. 7, 2002 (JP) 2002-061644
Dec. 19, 2002 (JP) 2002-368052

(51) Int. Cl. B01J 21/04

(52) U.S. Cl. 502/439

(57) ABSTRACT

This invention aims at providing a direct support ceramic support having less degradation of a catalyst due to thermal durability, and capable of keeping a high catalyst performance for a long time and suppressing a change of characteristics of a substrate ceramic. According to the invention, one or more kinds of constituent elements of a substrate ceramic such as cordierite are replaced by an element such as W to form a ceramic body having at least one kind of elements and fine pores each capable of directly supporting a catalyst component. These elements or fine pores are arranged at only an outermost surface layer portion (a depth corresponding to 1,000 unit crystal lattices or below) of the substrate ceramic. A catalyst body undergoing less thermal degradation and having small influences on the characteristics of the substrate ceramic is thus obtained.

### BACKGROUND OF THE INVENTION

1. Field of the Invention

This invention relates to a support used as a support for an exhaust gas purification catalyst of an automobile engine, its production method, and a catalyst body.

2. Description of the Related Art

Various proposals have been made in the past to purify detrimental substances emitted from an automobile engine. The exhaust gas purification catalyst generally uses a cordierite honeycomb structure having high terminal impact resistance as a support. After a coating layer formed of a material having a high specific surface area such as γ-alumina is formed on a surface, a catalyst precious metal such as Pt is supported. The reason why the coating layer is formed is because cordierite has a small specific surface area and a necessary amount of the catalyst component can be supported when the surface area of the support is increased by use of a material having a high specific surface such as γ-alumina.

However, the formation of the coating layer invites an increase of a thermal capacity of the support and is therefore disadvantageous for early activation. Since an open area becomes small, a pressure loss will increase, too. Moreover, because γ-alumina has low heat resistance by itself, there remains the problem that the catalyst component undergoes aggregation and purification performance greatly drops. Therefore, a greater amount of the catalyst component must be supported in consideration of this degradation. For this reason, a method of directly supporting a necessary amount of the catalyst component, without forming the coating layer, has been sought in recent years. For example, Japanese Examined Patent Publication (Kokoku) No. 5-50338 proposes a method that conducts acid treatment and heat treatment to elute specific components and improves the specific surface area of the cordierite itself. However, this method involves the problem that the acid treatment and the heat treatment destroy the crystal lattice of cordierite and lower the strength.

On the other hand, the inventors of this invention have previously proposed a ceramic support that does not require a coating layer for improving a specific surface area but can support a necessary amount of catalyst components without lowering the strength (Japanese Unexamined Patent Publication (Kokai) No. 2001-310128). This ceramic support forms micro pores, that cannot be measured as a specific surface area, such as oxygen defects and lattice defects in a crystal lattice, very fine cracks having a width of 100 nm or below, etc, and supports a catalyst. Therefore, the ceramic support can directly support the catalyst component while keeping the strength.

To form the lattice defect, the ceramic support described above is produced by the steps of preparing elements (tungsten, for example) other than constituent elements of a substrate ceramic with the substrate ceramic that uses talc, kaolin and alumina as the starting materials, adding a molding assistant, water, etc, kneading the mixture to form a clay, and extrusion-molding the clay. In the ceramic support thus produced, the elements other than the ceramic constituent elements uniformly exist therein.

However, the elements other than the substrate ceramic constituent elements that exist inside the ceramic support do not at all contribute to supporting of the catalyst but may raise a coefficient of thermal expansion of the substrate ceramic. More concretely, the elements other than the substrate ceramic constituent elements may double, in some cases, the coefficient of thermal expansion.

It has therefore been a problem how to suppress the rise of the coefficient of thermal expansion to a minimum level. It has also been desired to suppress the grain growth of the catalyst components when the catalyst body is used at a high temperature for a long time, and to further improve purification performance.

It is therefore an object of the invention to acquire a direct support ceramic support capable of keeping high catalyst performance for a long time by suppressing changes of characteristics of a substrate ceramic and by further reducing degradation of a catalyst due to thermal durability.

### SUMMARY OF THE INVENTION

According to a first aspect of the invention, there is provided a support having at least one kind of fine pores and elements each capable of directly supporting catalyst components on a surface of a substrate ceramic, wherein the fine pores and the elements, each capable of directly supporting the catalyst components, exist at only the outermost surface layer portion of the substrate ceramic. The term “outermost surface layer portion” means a boundary portion between a solid phase (ceramic) and a gaseous phase or a liquid phase, and is a portion having a predetermined depth from the outermost surface (inclusive of concavo-convexities on the ceramic surface and inner/outer surfaces of pores) as the solid phase.

In the support according to the invention, as the fine pores or the elements directly support the catalyst component, bonding strength with the catalyst component is higher than in the prior art supports, and the present support is also free from the problems of thermal degradation of the coating layer having a large specific surface area and the drop of the strength. Consequently, it is not necessary to support a greater amount of the catalyst component in view of degradation. As the fine pores or the elements are arranged only at the outermost surface layer portion of the substrate ceramic, the elements other than the constituent elements of the substrate ceramic do not exist inside, and an influence on the characteristics of the substrate ceramic itself such as a coefficient of thermal expansion is small. Therefore, it becomes possible to improve thermal durability while making the most of the excellent characteristics of the substrate ceramic, and to keep a high catalyst performance for a long time.

The outermost surface layer portion of the substrate ceramic at which the fine pores or the elements exist may have a depth corresponding to not greater than 1,000 unit cells of crystal lattice of the ceramic. The change of the characteristics of the substrate ceramic can be effectively made small within this range.

The outermost surface layer portion of the substrate ceramic at which the fine pores or the elements exist may have a depth corresponding to not greater than 200 unit cells of crystal lattice of the ceramic. The smaller the depth of the outermost surface layer portion, the smaller becomes the influence on the substrate ceramic.

According to a second aspect of the invention, there is provided a support including a substrate layer and a support layer formed on a surface of the substrate layer, wherein the support layer is formed of a ceramic having at least one kind of fine pores and elements each capable of directly supporting catalyst components on a surface of a substrate ceramic.

Unlike the coating layer of the prior art supports, the fine pores or the elements of the support layer described above directly support the catalyst component. Therefore, the support is highly resistant to thermal degradation and has a high bonding strength. In consequence, the support amount of the catalyst component can be decreased, and the thickness can be drastically reduced in comparison with the coating layer of the prior art supports. Moreover, because the substrate layer can be formed of a material different from that of the support layer such as a material having higher thermal and mechanical characteristics than the material of the support layer, it becomes possible to improve thermal durability while making the most of the excellent characteristics of the substrate layer, and to keep a high catalyst performance for a long time.

The substrate layer may be formed of ceramic or a metal. More concretely, the same ceramic or metal as that of the support layer can be used as the substrate, and a support having desired characteristics can be easily obtained depending on the intended application.

The substrate layer may have higher mechanical and thermal characteristics than the substrate ceramic constituting the support layer. In consequence, improvement of the characteristics of the support and improvement of catalyst performance can be satisfied easily and simultaneously.

In the third or second aspect of the invention described above, the fine pore comprises at least one kind of members selected from defect in the ceramic crystal lattice, fine crack on the surface of the ceramic and defect of elements constituting the ceramic. More concretely, the support can acquire the effects described above when the fine pores comprising at least one kind of the members described above are formed at only the outermost surface layer portion.

The width of the fine cracks described may be 100 nm or below, and this range is preferable for securing the support strength.

To support the catalyst component, the fine pore may have a diameter or width 1,000 times or less than the diameter of a catalyst ion to be supported, and the number of the fine pores is at least 1×10¹¹/L. When these conditions are satisfied, an equivalent amount of the catalyst component, to that of the prior art supports, can be supported.

The pore described above is defect formed by replacing one or more kinds of constituent elements of the substrate ceramic by a replacing element or elements other than the constituent elements. When the replacing element is an element having different valence from that of the constituent elements, the oxygen defect or the lattice defect is created, and this defect can directly support the catalyst component.

The element described above may be a replacing element introduced by replacing one or more kinds of constituent elements of the substrate ceramic by an element or elements other than the constituent elements. Since the replacing element or elements can directly support the catalyst component, the support has higher bonding strength and undergos thermal degradation with difficulty.

The catalyst component can be supported on the replacing element through chemical bonding. As the catalyst component is chemically bonded with the replacing element, retainability can be improved and aggregation becomes more difficult to occur. As the catalyst component is uniformly dispersed, a high performance can be maintained for a long time.

The replacing element described above may be one or more kinds of elements having a d or f orbit in an electron orbit thereof. The element having the d or f orbit can easily combine with the catalyst component and is therefore effective for improving the bonding strength.

According to a third aspect of the invention, there is provided a method of producing a support having an element capable of directly supporting a catalyst component at an outermost surface layer portion of a substrate ceramic, the element being a replacing element introduced by replacing one or more kinds of constituent elements of the substrate ceramic by an element or elements other than the constituent elements, the method comprising the steps of molding starting materials of the substrate ceramic; forming a layer containing the replacing elements ionized on a surface of the resulting molding; and firing the molding and at the same time, bonding the replacing element with the substrate ceramic.

Since this method can arrange the replacing element at only the outermost surface layer portion of the substrate ceramic, the support according to the invention can be easily obtained by conducting simultaneous firing.

According to a fourth aspect of the invention, there is provided a method of producing a support having an element capable of directly supporting a catalyst component at an outermost surface layer portion of a substrate ceramic, the element being a replacing element introduced by replacing one or more kinds of constituent elements of the substrate ceramic by an element or elements other than the constituent elements, the method comprising the steps of molding and firing starting materials of the substrate ceramic; removing a part of the ceramic constituent elements of an outermost surface layer portion of the resulting fired body; forming a layer containing the replacing elements ionized on a surface of the outermost surface layer portion from which a part of the constituent elements is removed; and bonding the replacing element with the substrate ceramic.

According to the method described above, after the substrate ceramic is fired, a part of the constituent elements on the surface of the substrate ceramic is removed and the replacing element is arranged. In consequence, only the outermost surface layer portion can be subjected to element substitution, and influences on the substrate ceramic can be reduced.

A solution containing the replacing element or a salt of the replacing element may be coated to form a layer containing the replacing element. When the solution is used, the ionized replacing element can be easily arranged at the surface of the molding or the outermost surface layer portion of the fired body from which a part of the constituent elements is removed.

As means for removing a part of the ceramic constituent elements in the embodiment described above, it is possible to use wet etching, dry etching or sputter-etching. When these treatments are applied, only the constituent elements of the outermost surface portion can be removed.

Heat treatment may be carried out to bond the replacing element with the substrate ceramic. Element substitution can be easily achieved when the ions of the replacing element are arranged on the outermost surface layer portion of the fired body from which a part of the constituent elements is removed, and heat treatment is then carried out.

The substrate ceramic may contain, as its main component, cordierite, alumina, spinel, mullite, aluminum titanate, zirconium phosphate, silicon carbide, silicon nitride, zeolite, perovskite or silica-alumina. When the replacing element is introduced into these ceramics, a support that has high bonding strength undergos thermal degradation with difficulty can be obtained.

According to a fifth aspect of the invention, there is obtained a catalyst body that directly supports the catalyst component on its support according to the first or second aspect of the invention, and that undergos degradation with difficulty even when used for a long time.

### BRIEF DESCRIPTION OF THE DRAWINGS

FIG. 1 is a schematic structural view showing a shape of a support and arrangement of replacing elements according to a first embodiment of the invention;

FIG. 2 is a schematic view showing a ceramic support surface portion for defining an outermost surface layer portion of the substrate ceramic;

FIG. 3 is a schematic view showing a state where a crystal lattice corresponding to only one element is replaced from the outermost surface of the substrate ceramic;

FIGS. 4(a) to 4(c) are explanatory views for explaining a production method of the support according to the first embodiment of the invention, wherein:

FIG. 4(a) shows the state before acid treatment;

FIG. 4(b) shows the state after the acid treatment; and

FIG. 4(c) shows the state after coating of a replacing element and heat treatment;

FIG. 5(a) is a schematic view showing the state where the element of the outermost surface of the substrate ceramic is removed;

FIG. 5(b) is a schematic view showing the state where a replacing element fills the site of the element removed;

FIG. 6(a) is a schematic view showing the state where catalyst components are supported on the entire surface of the ceramic support inclusive of pores;

FIG. 6(b) is a schematic view showing the state where the catalyst components are supported on the entire surface of the ceramic support exclusive of pores; and

FIG. 7 is a schematic sectional view showing a structure of a support according to a second embodiment of the invention.

### DESCRIPTION OF THE PREFERRED EMBODIMENTS

The invention will be hereinafter explained in detail with reference to the accompanying drawings. A support according to a first embodiment of the invention is a ceramic support having fire pores or elements that can directly support the catalyst component on the surface of a substrate ceramic, and the pores or the element can directly support the catalyst component. In the first embodiment, the fine pores or the element exists on only the outermost surface layer portion of the substrate ceramic. As the substrate ceramic of the ceramic support, a substrate ceramic containing cordierite having a theoretical composition of 2MgO.2Al₂O₃.5SiO₂ as a main component, for example, is used appropriately. A ceramic catalyst body produced by directly supporting catalyst precious metals such as Pt, Rh and Pd as the catalyst components on this ceramic support can be appropriately used for a support of an exhaust gas purification catalyst of automobiles.

To produce the ceramic support, the substrate ceramic is molded into a predetermined shape and is then fired. The ceramic support may have a honeycomb structure having a large number of rectangular cells in parallel with a gas flowing direction as shown in FIG. 1, for example. FIG. 1 shows an example where replacing elements 2 are introduced into the substrate ceramic 1 so that the catalyst component can be directly supported. At this time, the replacing elements are arranged on only the cell wall surface as a flow wall as shown in the drawing. The shape of the cells 3 is not limited to the rectangle but may take various shapes. The support shape, too, is not limited to the honeycomb structure but may take various other shapes such as pellet, powder, foam, hollow fiber, fiber, and so forth. Cordierite has high heat resistance and is suitable as a support of an automobile catalyst used under a high temperature condition. It is also possible to use ceramics other than cordierite, such as those containing alumina, spinel, mullite, aluminum titanate, zirconium phosphate, silicon carbide, silicon nitride, zeolite, perovskite, or silica-alumina as their main components.

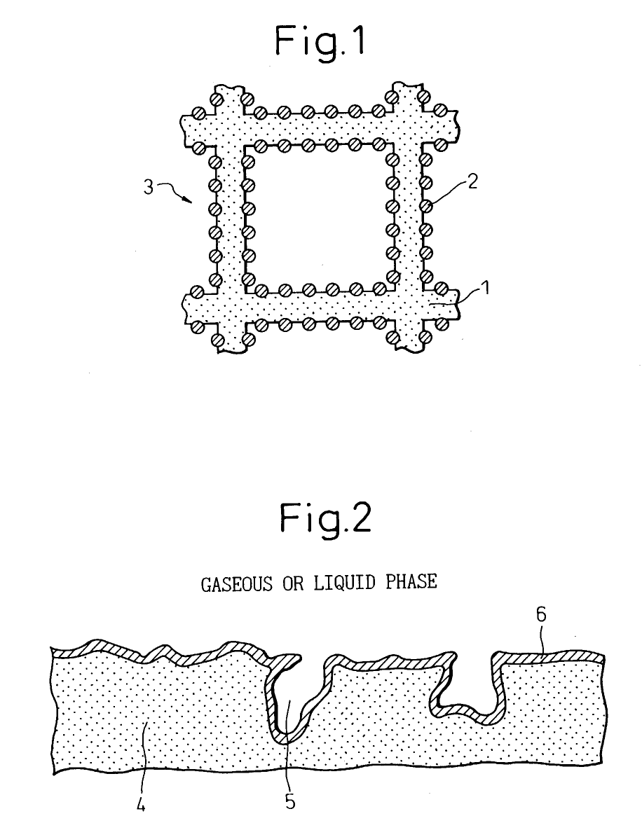

To directly support the catalyst components, the ceramic support according to the first embodiment of the invention has a large number of either one, or both, of fine pores and elements each capable of directly supporting the catalyst components at the outermost surface layer portion of the substrate ceramic. Here, the term “outermost surface layer portion” means a boundary portion between a solid phase (ceramic) and a gaseous phase or a liquid phase. A large number of pores and concavo-convexities exist on the surface of the ceramic support having a shape of a honeycomb body or a pellet as shown in FIG. 2. The liquid phase and the gaseous phase used for supporting the catalyst such as a solution and an exhaust gas enter the inside of the concavo-convexities and the pores 5 existing on the surface of the ceramic support as the solid phase. Therefore, the outermost surface layer portion 6 is defined as the boundary portion between the ceramic as the solid phase and the gaseous phase or the liquid phase, and is the portion having a predetermined depth from the outermost surface inclusive of the inner and outer surfaces of these concavo-convexities and the inner surface of the pores as shown in FIG. 2.

The fine pores capable of directly supporting the catalyst component concretely include the defect (oxygen defect or lattice defect) in the ceramic crystal lattice. In addition, fine cracks on the ceramic surface and defects of the elements constituting the ceramic can also be used. One or a plurality of kinds of defects is combined with one another. The element capable of directly supporting the catalyst component is the element introduced by replacing one or more kinds of the elements constituting the substrate ceramic by an element other than the constituent elements. This element can chemically couple with the chemical component. In the ceramic support according to the invention, the fine pores or the element directly support the catalyst component as they are coupled physically or chemically with the catalyst component, and can support the catalyst component without forming the coating layer having a high specific surface area such as γ-alumina while suppressing the change of the characteristics of the substrate ceramic and the drop of the strength.

Next, the fire pores capable of directly supporting the catalyst component will be explained. The diameter of the catalyst component ion to be supported is generally about 0.1 nm. Therefore, if the fine pores formed on the surface of cordierite are at least 0.1 nm in diameter or width, the fine pores can support the catalyst component ion. To secure the strength of the ceramic, the diameter or width of the fine pores is smaller than 1,000 times (100 nm) the diameter of the catalyst component ion and is preferably as small as possible. The diameter or width is preferably 1 to 1,000 times (0.1 to 100 nm). The depth of the fine pores is preferably at least ½ times (0.05 nm) the diameter to support the catalyst component ion. To support the catalyst component in an amount equivalent to the conventional amount (1.5 g/L) at this size, the number of fine pores is at least 1×10¹¹/L, preferably 1×10¹⁶/L and more preferably at least 1×10¹⁷/L.

As to the fine pores formed on the ceramic surface, the defect of the crystal lattice includes the oxygen defect and the lattice defect (metal vacant lattice point and lattice strain). The oxygen defect is the defect that is created when oxygen for constituting the ceramic crystal lattice becomes insufficient. The fine pores formed by fall-off of oxygen can support the catalyst component. The lattice defect is the defect that occurs when oxygen is entrapped in an amount greater than necessary for constituting the ceramic crystal lattice. The catalyst component can be supported in the fine pores formed by the strain of the crystal lattice and by the metal vacant lattice point.

Concretely, the number of fine pores of the ceramic support exceeds the predetermined number described above when the cordierite honeycomb structure contains at least 4×10⁻⁶%, preferably at least 4×10⁻⁵%, of cordierite crystals having at least one kind of oxygen defect or lattice defect in a unit crystal lattice, or contains 4×10⁻⁸ pieces, preferably at least 4×10⁻⁷ pieces, of at least one kind of oxygen defect or lattice defect in a unit cell of a crystal lattice of cordierite.

A method of creating the defects in the crystal lattice is described in the afore-mentioned patent reference 2. For example, the oxygen defect can be created by replacing a part of at least one kind of constituent elements other than oxygen of the cordierite material containing an Si source, an Al source and an Mg source by an element having smaller valence than the constituent element during a molding, degreasing and firing process. In the case of cordierite, the constituent elements have positive charges, that is, Si (4+), Al (3+) and Mg (2+). When these elements are replaced by elements having smaller valence, the positive charge corresponding to the difference of valence from the replacing element and to the replacing amount becomes insufficient, O (2−) having the negative charge is emitted to keep electric neutrality as the crystal lattice, and the oxygen defect is formed.

The lattice defect can be created by replacing a part of the ceramic constituent elements other than oxygen by an element having greater valence than the constituent elements. When at least a part of the Si, Al and Mg as the constituent elements of cordierite is replaced by an element having greater valence, the positive charge becomes excessive in the amount corresponding to the difference of valence from the replacing element and to the replacing amount, and O (2−) having the negative charge is entrapped in an amount necessary for keeping electric neutrality as the crystal lattice. Oxygen so entrapped becomes an obstacle and the cordierite crystal lattice cannot be aligned in regular order, thereby creating the lattice strain. The firing atmosphere in this case is an atmosphere so that oxygen can be sufficiently supplied. Alternatively, a part of Si, Al and Mg is emitted to keep electric neutrality, and voids are formed. Since the size of these defects is believed to be several angstroms or below, the defects cannot be measured as a specific surface area by an ordinary measurement method of a specific surface area such as a BET method using nitrogen molecules.

The numbers of the oxygen and lattice defects have correlation with the oxygen amount contained in cordierite. To support the necessary amount of the catalyst component described above, the oxygen amount is preferably less than 47 wt % (oxygen defect) or greater than 48 wt % (lattice defect). When the oxygen amount is less than 47 wt % due to the formation of the oxygen defect, the oxygen number contained in the cordierite unit crystal lattice becomes smaller than 17.2, and the lattice constant of the bₒ, axis of the crystal axis of cordierite is smaller than 16.99. When the oxygen amount becomes greater than 48 wt % due to the formation of the lattice defect, the oxygen number contained in the cordierite unit crystal lattice becomes greater than 17.6, and the lattice constant of the bₒ. axis of the crystal axis of cordierite becomes greater or smaller than 16.99. Since it is only the outermost surface layer in the invention at which the oxygen defect and the lattice defect are created, the oxygen number described above is attained only at the outermost surface layer portion, and the oxygen number of the substrate ceramic portion is 17.2.

Next, the elements capable of directly supporting the catalyst component will be explained. To directly support the catalyst components in the ceramic support according to the invention, the elements for replacing the constituent elements of the substrate ceramic, or the elements for replacing Si, Al and Mg as the constituent elements other than oxygen in the case of cordierite, for example, have higher support strength of the catalyst component to be supported than the constituent elements, and can support the catalyst components through chemical bonding. More concretely, the replacing elements are different from the constituent elements and have a d or f orbit in their electron orbit. Preferably, the replacing elements have a vacant orbit in the d or f orbit and two or more oxidation states. The elements having the vacant orbit in the d or f orbit have an approximate energy level to that the catalyst components, that are to be supported, can easily exchange the electrons and can easily couple with the catalyst components. The elements having two oxidation states, too, can easily exchange the electrons and are expected to provide the similar operations because the exchange of the electrons occurs relatively easily.

Concrete examples of the elements having the vacant orbit in the d or f orbit are W, Ti, V, Cr, Mn, Fe, Co, Ni, Zr, Mo, Ru, Rh, Ce, Ir and Pt. At least one kind of these elements can be used. Among these elements, W, Ti, V, Cr, Mn, Fe, Co, Mo, Ru, Rh, Ce, Ir and Pt are the elements having two or more oxidation states.

The amount of the replacing element is such that the total replacing amount is 0.01 to 50%, preferably 5 to 20%, of the atomic number of the constituent elements to be replaced. When the replacing element has different valence from that of the constituent element of the ceramic, the lattice defect or the oxygen defect simultaneously occurs in accordance with the difference of valence. The fine pores created by these defects can support the catalyst component. In this case, a plurality of replacing elements is used in such a fashion that the sum of the oxidation number of the replacing elements is equal to the sum of the oxidation number of the constituent elements to be replaced. As the change of valence does not occur as a whole in this case, the defects are not created. In this way, this method can support the catalyst component through only chemical bonding with the replacing element, and resistance to degradation becomes higher.

When the ceramic support in which a part of the constituent elements of the substrate ceramic is subjected to element substitution and the resulting fine pores or replacing elements can support the catalyst component is used as described above, it becomes possible to directly support the catalyst component without coating layer to strengthen bonding with the substrate ceramic and to improve durability. Particularly when the element introduced by replacing directly couples with the catalyst component, bonding with the substrate ceramic becomes stronger.

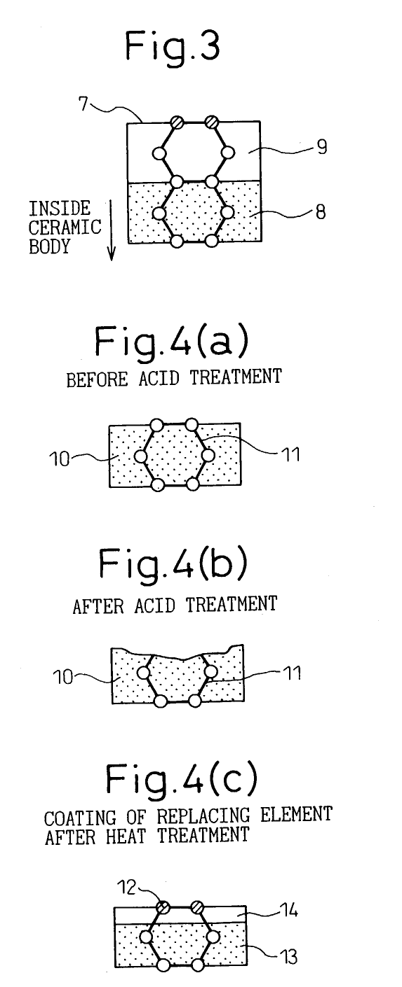

In the invention, the fine pores or elements each capable of supporting the catalyst component are allowed to exist in only the crystal lattice of the outermost surface layer portion of the substrate ceramic in order to form the fine pores capable of supporting the catalyst component or to introduce the elements capable of supporting the catalyst component through element substitution and to eliminate the problem of the increase of the coefficient of thermal expansion of the substrate ceramic. More concretely, when the crystal lattice having the outer surface layer portion through the element substitution has a depth smaller than a depth (about 1 μm) corresponding to 1,000 unit crystal lattices from the outermost surface of the substrate ceramic, the increase of the coefficient of thermal expansion due to element substitution can be made smaller than the increase (0.5×10⁻⁶/° C.) of the coefficient of thermal expansion when γ-alumina is coated. Preferably, the outermost surface layer portion is smaller than the depth (about 200 nm) corresponding to 200 unit crystal lattices, and the increase of the coefficient of thermal expansion is 0.1×10⁻⁶/° C. or below. The smaller the thickness of the substrate ceramic replaced, the smaller becomes the influence on the characteristics of the substrate ceramic. More preferably, the outermost surface layer portion has a depth (about 1 nm) corresponding to one unit crystal lattice. FIG. 3 is a schematic view showing the state where only the crystal lattice corresponding to one unit crystal lattice is subjected to element substitution. Reference numeral 7 represents the outermost surface of the ceramic body. Reference numeral 8 denotes the unit crystal lattice of the substrate ceramic and reference numeral 9 denotes the replaced unit crystal lattice.

To form or introduce the fine pores or the replacing elements each capable of supporting the catalyst components, the following two method can be broadly employed as a method of replacing a part of the ceramic constituent elements of the outermost surface layer portion of the substrate ceramic.

\mathring{1} A coating layer containing ionized replacing elements is formed on the surface of a molding of the substrate ceramic, and only the crystal lattice of the outermost surface layer portion is subjected to element substitution simultaneously with firing.

\mathring{2} A part of the constituent elements is removed from the outermost surface layer portion of the fired body of the substrate ceramic to form a coating layer containing the ionized replacing elements, and heat-treatment is carried out to replace a part of the removed constituent elements by the replacing element.

Next, these methods will be explained in detail.

According to the method \mathring{1}, the ceramic starting materials are kneaded in a customary manner and the mixture is molded into a honeycomb structure, for example. When the honeycomb structure is formed, the thickness of cell walls of the ceramic support is generally 150 μm or below. The wall thickness is preferably as small as possible because the thermal capacity becomes smaller. After this molding is dried, the dried molding is immersed in a solution containing the replacing elements. The dried molding is taken out from the solution and is dried to form the coating layer containing the replacing elements. Water or an alcohol such as ethanol can be used as the solvent. Alternatively, a salt containing the replacing elements may be applied to form the coating layer.

Firing is thereafter carried out in a customary manner and the replacing elements coated on the surface simultaneously react with the starting materials of the substrate ceramic, thereby conducting element substitution. Firing is generally carried out by heating and degreasing the molding, and then holding it at a temperature higher than the firing temperature of the ceramic in the open atmosphere for a predetermined time. As the replacing elements are used for element substitution on the surface of the ceramic support, they do not enter the inside of the ceramic support. Therefore, the coefficient of thermal expansion of the ceramic support after firing remains equal to that of the substrate ceramic, or rises to a certain extent. The element substitution amount can be regulated depending on the amounts of the replacing elements to be coated.

According to the method \mathring{2}, the ceramic starting materials are similarly kneaded, and the mixture is molded into a honeycomb structure, for example, and is dried. The molding is then fired in a customary manner. At least a part of the ceramic constituent elements of the outermost surface layer portion of this fired structure is removed. Wet etching such as acid treatment, dry etching or sputtering can be employed as the method for removing the constituent elements. When the fired structure is subjected to the acid treatment by, for example, immersing it into aqua regia for a predetermined time as shown in FIGS. 4(a) to 4(c), a part of the constituent elements of the outermost surface portion keeping touch with aqua regia elutes (FIGS. 4(a) and 4(b)). Reference numeral 10 denotes the crystal grains of the ceramic and reference numeral 11 denotes the crystal lattice of the substrate ceramic. Next, the fired structure is immersed in a solution containing therein the replacing elements, is taken out and is then dried to form the coating layer containing the replacing elements. Water or an alcohol such as ethanol is used as the solvent. A salt containing the replacing elements may be applied to form the coating layer.

When heat-treatment is thereafter carried out, the portion from which a part of the constituent elements is removed holds the replacing element coated on the surface, thereby executing element substitution. In consequence, only the outermost surface portion of the substrate ceramic becomes the layer into which the replacing element is introduced (4(c)). As the replacing element is used for element substitution on the surface of the ceramic support in this case, too, it does not enter the inside, and the coefficient of thermal expansion of the ceramic support after firing is equal to the coefficient of thermal expansion of the substrate ceramic, or rises to a certain extent. The element substitution amount can be regulated depending on the amount of the replacing element to be coated. In FIG. 4(c), reference numeral 12 denotes the replacing element. Reference numeral 13 denotes the substrate ceramic layer and reference numeral 14 denotes the replaced layer (outermost surface layer portion).

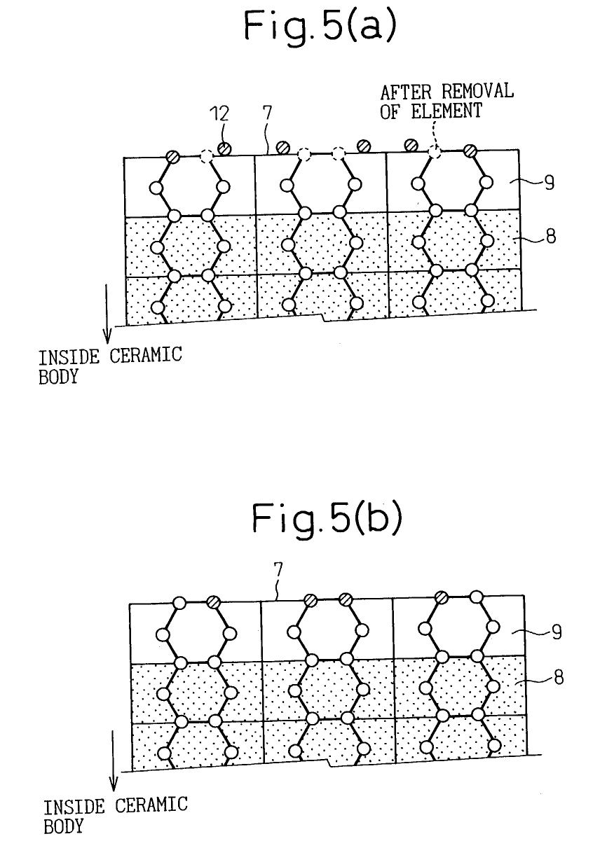

FIGS. 5(a) and 5(b) are schematic views each showing element substitution in further detail. A part of the constituent elements of the outermost surface layer portion is cut off by means such as sputtering-etching, the replacing element is coated and heat-treatment is then carried out as shown in FIG. 5(a). In consequence, the replacing element existing nearby enters the portion from which the element is removed as shown in FIG. 5(b). In the invention, the portion from which a part of the constituent element is removed is not left as such but is buried by the replacing element through element substitution. Therefore, the structure of the crystal lattice is kept as such. Because element substitution does not occur at portions other than the outermost surface layer portion, the strength can be secured.

When surface treatment is carried out after firing and the replacing element is coated to conduct element substitution as described above, element substitution of only the outermost surface portion can be more easily made than in the method \mathring{1}. According to the method that causes the dried structure after molding to be impregnated with the solution of the replacing element, the replacing element is more likely to diffuse into the inside. According to the method \mathring{2}, on the other hand, the defect created by removing the constituent elements exists at only the outermost surface layer portion, and the replacing elements do not easily diffuse into the inside of the fired structure.

The catalyst body according to the invention can be obtained by causing the ceramic support having the fine pores or the elements each of which can directly support the catalyst component and which are arranged at the outermost surface layer portion to directly support a desired catalyst component such as a ternary catalyst, a perovskite catalyst, a NOx catalyst, and so forth. Supporting of the catalyst component can be achieved by an ordinary method that immerses the ceramic support in a solution containing the catalyst components and then conducts firing. When a plurality of catalyst components is supported, the method of immersing the ceramic support in a solution containing each catalyst component and conducting firing is repeated. Alternatively, the catalyst components can be simultaneously supported by immersing the ceramic support into a solution containing a plurality of catalyst components and then conducting firing. The catalyst particles have a mean particle diameter of 100 nm or below and preferably 50 nm or below. The smaller the mean particle diameter, the more highly the catalyst particles can be dispersed on the support surface, and purification performance per unit catalyst weight can be improved. Besides the precious metals such as Pt, Rh and Pd, base metals such as Cu and Ni and metal oxides of Ce, Li, etc, can be selected as the main catalyst components or the assistant catalyst components.

When the replacing element has the catalyst operation, a ceramic catalyst body having purification performance can be obtained even when the catalyst component is not supported. Platinum (Pt), for example, is the element that has the d or f orbit and moreover has two or more oxidation states. Therefore, Pt can be used as the replacing element having the catalyst capability. The ceramic catalyst body so produced has a firing temperature higher than a thermal durability temperature, and does not therefore undergo degradation even by thermal durability at 1,000° C. for 24 hours. Purification performance can be further improved when this catalyst body is allowed to support the catalyst components.

In the ceramic catalyst body obtained in this way, the fine pores or the elements directly support the catalyst components without the coating layer, the problem of thermal degradation does not occur, and bonding is firm. Particularly when the catalyst component is chemically bonded with the replacing element, the bonding strength becomes higher and degradation becomes more difficult to occur. Moreover, because the fine pores or the elements capable of directly supporting the catalyst components are allowed to exist on only the outermost surface layer portion, the characteristics of the substrate ceramic such as the coefficient of thermal expansion are hardly affected. For example, when γ-alumina is coated to the cordierite honeycomb structure, the coefficient of thermal expansion increases by 0.5×10⁻⁶/° C. or more, but the increase of the coefficient of thermal expansion by element substitution is smaller and is generally 0.1×10⁻⁶/° C. or below. Because the coating layer is not necessary, the ceramic catalyst body has a low thermal capacity and a low pressure loss, and the drop of catalyst performance due to degradation of the coating layer itself does not occur.

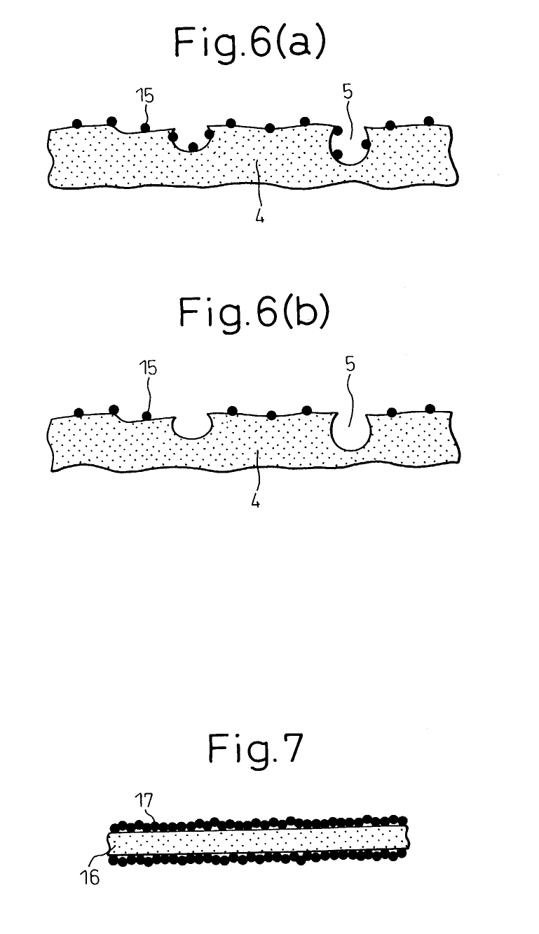

Incidentally, pores 5 generally exist on the surface of the ceramic support 4 as shown in FIGS. 6(a) and 6(b). These pores 5 are formed when an inflammable matter burns and a gas is degassed during firing, or when talc as the starting material is molten in the case of cordierite. The replacing elements exist in the outermost surface layer portion inside these pores, too, as described above. The ceramic catalyst body 4 according to the invention may take either the case where the catalyst components are supported on the entire outermost surface of the ceramic support as shown in FIG. 6(a), or the case where the catalyst components are supported on the surface exclusive of the surface inside the pores as shown in FIG. 6(b). These cases may be appropriately selected depending on the application.

In the case (wall flow type) where the exhaust gas flows in such a manner as to pass through the cell walls of the honeycomb as in a particulate collection filter (DPF), the exhaust gas flows through inside the pores, too. Therefore, the catalyst supported by the pores greatly contributes to purification of the exhaust gas, and purification performance can be improved when the construction shown in FIG. 6(a), in which the catalyst is highly dispersed, is employed. On the other hand, in the case (flow-through type) where the exhaust gas flows in parallel with the cell walls of the honeycomb as in a monolithic support, contribution of the catalyst supported by the pores to purification of the exhaust gas is small. Therefore, when the catalyst is supported on the surface exclusive of the inner surface of the pores as the construction shown in FIG. 6(b), the catalyst support amount can be decreased while purification performance is kept at an equal level. The construction in which the catalyst component is not supported inside the pores can be achieved by coating in advance a binder to the surface of the ceramic support, immersing the ceramic support into a catalyst solution for only a limited time and conducting heat-treatment.

FIG. 7 shows a second embodiment of the invention. The support in this embodiment includes a substrate layer 16 and a support layer 17 formed on the surfaces of the substrate layer 16. When the catalyst components are supported on the support layer 17, a catalyst body having a catalyst layer at its outermost surface layer portion can be acquired. The support layer is made of a ceramic having at least either one kind of fine pore and elements each capable of directly supporting the catalyst components on the surface of the substrate ceramic, and has higher bonding strength with the catalyst components than with the substrate layer. The substrate layer preferably has higher mechanical and thermal characteristics than the support layer, and can appropriately use a ceramic body obtained by molding and firing a ceramic having mechanical and thermal characteristics equivalent to, or higher than, those of cordierite, for example. Other ceramics such as the ceramic used as the substrate ceramic in the support of the first embodiment described above can be used, too. Further, the substrate layer can be formed of materials other than the ceramic, such as a metal excellent in both mechanical and thermal characteristics. The support shape may be arbitrary besides the honeycomb structure (wall flow type and flow-through type) shown in FIG. 1.

To enable the support to directly support the catalyst components, the support according to the second embodiment has the outermost surface layer portion formed of a support layer capable of directly supporting the catalyst components. The support layer has the same construction as the outermost surface layer portion of the first embodiment. The substrate ceramic preferably uses the ceramic such as cordierite used as the substrate ceramic in the first embodiment. The method of arranging the fine pores or elements each capable of directly supporting the catalyst components on the substrate ceramic is the same as the method described in the first embodiment. In the second embodiment, however, the support layer may be subjected, as a whole, to element substitution. It is possible to employ a method, for example, that decreases in advance a part of the starting materials of the substrate ceramic in accordance with the replacing amount, adds a compound of the replacing elements, and then conducts kneading, molding and firing in a customary manner. In consequence, the fine pores such as the lattice defects or the replacing elements that can easily combine with the catalyst components are introduced into the support layer, and the catalyst components can be directly supported.

Formation of the support layer is generally carried out by firing in advance the ceramic material having the fine pores and the elements each capable of directly supporting the catalyst components into powder and coating the powder to the surface of the substrate layer. At this time, if ceramic powder supporting the catalyst components is coated to the surface of the substrate layer, the catalyst body of the invention directly supporting the catalyst components at its outermost surface layer portion can be easily obtained simultaneously with the formation of the support layer. The catalyst components may of course be supported after the support layer is formed. It is further possible to prepare the ceramic materials in a dry powder form or a slurry form, to apply the powder or the slurry to the surface of the substrate layer and then to conduct firing.

The catalyst components supported by the catalyst layer is the same as in the first embodiment, and various metals or metal oxides such as a ternary catalyst, a perovskite catalyst, a NOx catalyst, and so forth, can be used. The supporting method of the catalyst components is similarly carried out. To support the catalyst components before ceramic powder is prepared, a ceramic fired body in which at least one kind of constituent elements of the substrate ceramic is replaced by other element by the same method as that of the first embodiment is immersed in a solution containing the catalyst components to a desired amount, and is then pulverized to about 1 to about 30 μm. A binder and water are added to this ceramic powder and slurry is formed. The slurry so obtained is applied onto the substrate layer and is fired at a temperature of 500 to 900° C. Alternatively, the ceramic fired body is in advance pulverized to about 1 to 30 μm, the catalyst components are supported, and firing is conducted at 500 to 900° C. Thereafter, the binder and water are added to form slurry, and the slurry is applied to the substrate layer and is then fired.

In the support according to the second embodiment, the substrate layer can be formed of a different material from the substrate ceramic of the support layer, and the material can be selected in accordance with required characteristics. In other words, the ceramic material or the metal material having high mechanical and thermal characteristics such as the strength, the coefficient of thermal expansion and the softening temperature is selected for the substrate layer, and the support layer formed of the ceramic material having a high bonding strength with the catalyst components and capable of directly supporting the catalyst components in the fine pores or the elements is arranged on the surface of the substrate layer. It is thus possible to provide a high-performance catalyst body the catalyst of which does not easily undergo thermal degradation while the desired mechanical and thermal characteristics are secured. Therefore, in comparison with the conventional catalyst body that supports a greater amount of the catalyst in consideration of degradation, the support layer according to this embodiment can reduce the catalyst amount to ½ or below of the prior art. In comparison with the thickness of the conventional coating layer (that is generally from 20 to 30 μm) formed of γ-alumina, this embodiment can decrease the thickness to ½ or below, and can therefore suppress the pressure loss to a lower level.

To increase the specific surface area, the ceramic material to operate as the support layer in the second embodiment may be subjected in advance to acid treatment. Alternatively, an inflammable material may be blended in the starting materials to increase porosity. An assistant catalyst component may be mixed in the ceramic materials to operate as the support layer and may be arranged on the surface of the substrate layer. The assistant catalyst component may of course be applied after the support layer is formed.

### EXAMPLES

### 1) Ion Coating of Replacing Element to Dried Body (Replacing Element: W)

Talc, kaolin, alumina and aluminum hydroxide were used as cordierite materials and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm. The molding so obtained was dried to give a dried honeycomb structure. To introduce an element capable of directly supporting the catalyst components, the dried honeycomb structure was immersed in an aqueous ammonium metatungstenate solution dissolving tungsten (W) as the replacing element in a concentration of 8×10⁻⁵ mol/L for one second. After the excess solution was removed, the honeycomb structure was dried and was fired at 1,390° C. in the atmosphere to obtain a ceramic support only the outermost surface layer portion of which was subjected to element substitution and which could directly support the catalyst component by the replacing element (W) (Example 1).

When the distribution of the replacing element in the direction of depth from the outermost surface of the fired cordierite was evaluated by XPS, the composition remained the cordierite composition containing the replacing element to a depth of about 200 nm (corresponding to 200 unit cells of crystal lattice) but was the cordierite composition not containing the replacing element at a deeper portion. The lattice constant of the portion having the depth of 200 nm from the outermost surface and that of the deeper portion determined by electron diffractiometry were different from each other. It was thus confirmed that the portion having the depth of 200 nm from the outermost surface was the element-substituted cordierite and the deeper portion was cordierite that was not element-substituted.

Next, to support Pt and Rh as the catalyst components on the ceramic support so obtained, an ethanol solution dissolving 0.035 mol/L of platinic chloride and 0.025 mol/L of rhodium chloride was prepared. The ceramic support was immersed in this solution for 5 minutes. After the excess solution was removed, the ceramic support was dried and was then fired at 600° C. in the atmosphere to metallize Pt and Rh. In this way was obtained a ceramic catalyst body in which Pt and Rh were metallized.

To evaluate purification performance of the resulting ceramic catalyst body, a model gas containing C₃H₆ was introduced and a 50% purification temperature of C₃H₆ was measured. The evaluation condition was listed below.

Model gas:

C₃H₆: 500 ppm

O₂: 5%

N₂: balance

SV=10,000

As a result, the ceramic catalyst body of Example 1 had an initial purification temperature of 187° C. and a 50% purification temperature after thermal durability of 297° C.

For comparison, on the other hand, a ceramic support was produced without conducting element substitution but forming a coating layer of γ-alumina on the surface of a cordierite honeycomb structure not having fine pores and elements each capable of supporting catalyst components. The same cordierite materials as those of Example 1 were prepared so that the composition became approximate to the theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm. The molding so obtained was dried and fired at 1,390° C. in the atmosphere. A ceramic support was produced by forming a coating layer (120 g/L) of γ-alumina on the surface of the cordierite honeycomb structure, and Pt and Rh were supported by the same method as described above to give a ceramic catalyst body (Comparative Example 1).

Purification performance of the ceramic catalyst body of Comparative Example 1 was similarly evaluated. As a result, the initial 50% purification temperature was 180° C. and was equal to that of Example 1. However, the 50% purification temperature after thermal durability was 397° C. and was higher by 100° C. presumably for the following reasons. Namely, in the product of the invention, the replacing element directly supported the catalyst components through chemical bonding and had higher bonding strength than the Comparative product in which the catalyst components were supported by the coating layer of γ-alumina, and the product of the invention had a greater effect of suppressing the grain growth of the catalyst components due to thermal durability, whereas the coating layer of γ-alumina itself of the Comparative product underwent thermal degradation.

When the coefficient of thermal expansion of the ceramic support of Example 1 was measured, it was 0.51×10⁻⁶/° C. The coefficient of thermal expansion of a ceramic support produced by using the same cordierite materials as those of Example 1 but not conducting element substitution by W was 0.40×10⁻⁶/° C. It was thus found that the increase of the coefficient of thermal expansion of the present product was limited to a slight increase of about 0.1×10⁻⁶/° C. In contrast, when the coefficient of thermal expansion of the ceramic support of Comparative Example 1 was measured, it was found to be 0.98×10⁻⁶/° C. and rose by 0.58×10⁻⁶/° C. in comparison with the coefficient of thermal expansion of the substrate ceramic.

It was thus confirmed that the product of the invention was resistant to thermal degradation, could keep a high purification performance after thermal durability, had a small coefficient of thermal expansion and had very small influences on the characteristics of the substrate ceramic.

### 2) Ion Coating of Replacing Element After Acid Treatment (Replacing Element: W)

Talc, kaolin, alumina and aluminum hydroxide were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm, was dried and was then fired at 1,390° C. in the atmosphere to give a fired body of the cordierite honeycomb structure. To remove a part of the constituent elements from the cordierite crystal lattice of the uppermost surface layer portion of the resulting honeycomb fired structure, the structure was immersed in aqua regia at room temperature for 6 hours for acid treatment. The structure was thereafter washed and was dried.

When the elements contained in the solution in which the fired honeycomb structure was immersed were analyzed, it was confirmed that because Mg was contained in the solution, Mg as a constituent element of cordierite eluted. To introduce an element capable of directly supporting the catalyst components after this Mg was removed, the dried honeycomb structure was immersed in an aqueous ammonium metatungstenate solution dissolving tungsten (W) as the replacing element in a concentration of 8×10⁻⁵ mol/L for 5 minutes. After the excessive solution was removed, the honeycomb structure was dried and was then fired at 1,200° C. in an atmosphere to obtain a ceramic support only the outermost surface layer portion of which was subjected to element substitution and which could directly support the catalyst component by the replacing element (W) (Example 2).

When the distribution of the replacing element in the direction of depth from the outermost surface of the fired cordierite was evaluated by XPS, the composition remained the cordierite composition containing the replacing element to a depth of about 30 nm (corresponding to 30 unit crystal lattices) but was the cordierite composition not containing the replacing element at a deeper portion. The lattice constant of the portion having the depth of 30 nm from the outermost surface and that of the deeper portion determined by electron diffractiometry were different from each other. It was thus confirmed that the portion having the depth of 30 nm from the outermost surface was the element-substituted cordierite and the deeper portion was cordierite that was not element-substituted.

Next, Pt and Rh as the catalyst components were supported on the resulting ceramic support in the same way as in Example 1 to give a ceramic catalyst body. When purification performance of the resulting ceramic catalyst body was similarly evaluated, it was found that the ceramic catalyst body of Example 2 had an initial 50% purification temperature of 184° C. that was equivalent to the initial 50% purification temperature (1800° C.) of Comparative Example 1 described above, but its 50% purification temperature after thermal durability was 289° C. and was lower by 108° C. than the 50% purification temperature (397° C.) after thermal durability in Comparative Example 1. This was because the bonding strength of the replacing element and the catalyst component in the present product was higher than that of the Comparative product, the present product could suppress the grain growth of the catalyst components due to thermal durability, and the coating layer itself of the Comparative product underwent degradation.

When the coefficient of thermal expansion of the ceramic support of Example 2 was measured, it was 0.42×10⁻⁶/° C., and the increase of the coefficient of thermal expansion was hardly observed in comparison with the coefficient of thermal expansion (0.40×10⁻⁶/° C.) of a ceramic support produced by using the same cordierite materials as those of Example 1 but not conducting element substitution by W.

### 2′) Ion Coating of Replacing Element After Acid Treatment (Replacing Element: Ga) (Replacing Element: Ga)

A fired body of a cordierite honeycomb structure was obtained by using the same cordierite materials as those of Example 2 and conducting, similarly, kneading, molding, drying and firing to obtain a fired body of a cordierite honeycomb structure (cell wall thickness of 100 μm, a cell density of 400 cpsi and a diameter of 50 mm). The resulting honeycomb fired body was immersed in aqua regia at room temperature for 2 hours for acid treatment. After a part of the constituent elements was allowed to elute from the cordierite crystal lattice of the outermost surface layer portion of the honeycomb fired body, the honeycomb fired body was washed and dried. At this time, when the elements contained in the solution in which the honeycomb fired body was immersed were analyzed, it was confirmed that Mg as the constituent element of cordierite eluted.

Next, to form the crystal defect by replacing Mg by an element having different valence from valence (2+) of Mg after this Mg was removed, the honeycomb fired body was immersed in an aqueous gallium chloride solution dissolving Ga (3+) as the replacing element in a concentration of 8×10⁻⁵ mol/L. After the excessive solution was removed, the fired honeycomb body was dried. The fired honeycomb body was then fired at 1,200° C. in the atmosphere to provide a ceramic support having fine pores (lattice defects) capable of directly supporting the catalyst components only at the outermost surface layer portion (Example 3).

Next, Pt and Rh as the catalyst components were supported on the resulting ceramic support in the same way as in Example 1 to give a ceramic catalyst body. Purification performance of the resulting ceramic catalyst body was similarly evaluated. As a result, it was found that the ceramic catalyst body of Example 3 had an initial 50% purification temperature of 192° C. that was equivalent to the initial 50% purification temperature (180° C.) of Comparative Example 1 described above, but its 50% purification temperature after thermal durability was 327° C. and was lower by 70° C. than the 50% purification temperature (397° C.) after thermal durability in Comparative Example 1.

When the coefficient of thermal expansion of the ceramic support of Example 3 was measured, it was 0.43×10⁻⁶/° C., and the increase of the coefficient of thermal expansion was hardly observed in comparison with the coefficient of thermal expansion (0.40×10⁻⁶/° C.) of a ceramic support produced by using the same cordierite materials as those of Example 1 but not conducting element substitution by W.

In comparison with Example 2, the 50% purification temperature of Example 3 after thermal durability was 327° C. and higher by 38° C. than that of Example 2. This was presumably because physical bonding between the lattice defect (fine pores) formed by element substitution by Ga and the chemical component was dominant in Example 3, whereas chemical bonding between W as the replacing element and the catalyst components was dominant in Example 2.

For comparison, a ceramic support in which lattice defects were created on the substrate ceramic as a whole was produced. To create the lattice defects, cordierite raw materials in which 5% of Mg as the cordierite constituent element was replaced by Ge having different valence were used. The cordierite materials were similarly kneaded, molded and fired to produce a ceramic support having a honeycomb structure. Pt and Rd were supported on this ceramic support in the same way as in Example 1 to give a ceramic catalyst body (Comparative Example 2).

When purification performance of the ceramic catalyst body of Comparative Example 2 was similarly evaluated, it was found that the ceramic catalyst body had an initial 50% purification temperature of 186° C. and a 50% purification temperature after thermal durability of 330° C. that were equivalent to those of Example 2. However, when the coefficient of thermal expansion of the ceramic support of Comparative Example 2 was measured, it was 0.85×10⁻⁶/° C. and rose to about twice the coefficient of thermal expansion (0.43×10⁻⁶/° C.) of Example 2. When the lattice defect was created not only on the outermost surface layer portion but also on the entire ceramic support in this way, the influences on the characteristics of the substrate ceramic became greater. In contrast, in the product of the invention in which only the outermost surface portion was subjected to element substitution, it was confirmed that the effect of suppressing the rise of the coefficient of thermal expansion was higher, and purification performance could be improved while the change of the characteristics of the substrate ceramic was suppressed.

3) Ion Coating of Replacing Element After Dry Etching (Replacing Element: W)

Talc, kaolin, alumina and aluminum hydroxide were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm, was dried and was then fired at 1,390° C. in the atmosphere to give a fired body of the cordierite honeycomb structure. To remove a part of the constituent elements from the uppermost surface layer portion of the fired body of the resulting honeycomb structure, the structure was dry etched for 10 minutes by use of CF₄ under the etching condition of a CF₄ flow rate of 150 ml/min, a pressure of a reaction chamber of 13.3 Pa, a frequency of 13.56 MHz and feed power of 300 W. Dry etching was conducted for 10 minutes. Next, the fired honeycomb structure from which a part of the constituent elements was removed was immersed in an aqueous ammonium metatungstenate solution dissolving tungsten (W) as the replacing element in a concentration of 8×10⁻⁵ mol/L for 5 minutes. After excessive solution was removed, the honeycomb structure was dried and was then fired at 1,200° C. in the atmosphere to obtain a ceramic support only the outermost surface layer portion of which was subjected to element substitution (Example 4).

When the distribution of the replacing element in the direction of depth from the outermost surface of the fired cordierite was evaluated by XPS, the composition remained the cordierite composition containing the replacing element till the depth of about 120 nm (corresponding to 120 unit cells of crystal lattice) but was the cordierite composition not containing the replacing element at a deeper portion. The lattice constant of the portion having the depth of 120 nm from the outermost surface and that of the deeper portion determined by electron diffractiometry were different from each other. It was thus confirmed that the portion having the depth of 120 nm from the outermost surface was the element-substituted cordierite and the deeper portion was cordierite that was not element-substituted.

Next, Pt and Rh as the catalyst components were supported on the resulting ceramic support in the same way as in Example 1 to give a ceramic catalyst body. Purification performance of the resulting ceramic catalyst body was similarly evaluated. As a result, it was found that the ceramic catalyst body of Example 4 had an initial 50% purification temperature of 185° C. that was equivalent to the initial 50% purification temperature (180° C.) of Comparative Example 1 described above, but its 50% purification temperature after thermal durability was 291° C. and was lower by 106° C. than the 50% purification temperature (397° C.) after thermal durability in Comparative Example 1.

When the coefficient of thermal expansion of the ceramic support of Example 4 was measured, it was 0.46×10⁻⁶/° C., and was substantially equivalent to the coefficient of thermal expansion (0.40×10⁻⁶/° C.) of a ceramic support produced by using the same cordierite materials as those of Example 1 but not conducting element substitution by W.

### 4) Ion Coating of Replacing Element After Sputter-Etching (Replacing Element: W)

Talc, kaolin, alumina and aluminum hydroxide were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm, was dried and was then fired at 1,390° C. in the atmosphere to give a fired body of the cordierite honeycomb structure. To remove a part of the constituent elements from the uppermost surface layer portion of the fired body of the resulting honeycomb structure, the structure was sputter-etched for 10 minutes by use of Ar under the etching condition of a pressure of a reaction chamber of 1.3 Pa, a frequency of 13.56 MHz and feed power of 100 W. Next, the fired honeycomb structure, from which a part of the constituent elements was removed, was immersed in an aqueous ammonium metatungstenate solution dissolving tungsten (W) as the replacing element in a concentration of 8×10⁻⁵ mol/L for 5 minutes. After excess solution was removed, the honeycomb structure was dried and was then fired at 1,200° C. in the atmosphere to obtain a ceramic support only the outermost surface layer portion of which was subjected to element substitution (Example 5).

When the distribution of the replacing element in the direction of depth from the outermost surface of the fired cordierite was evaluated by XPS, the composition remained the cordierite composition containing the replacing element to a depth of about 90 nm (corresponding to 90 unit crystal lattices) but was the cordierite composition not containing the replacing element at a deeper portion. The lattice constant of the portion having the depth of 90 nm from the outermost surface and that of the deeper portion determined by electron diffractiometry were different from each other. It was thus confirmed that the portion having the depth of 90 nm from the outermost surface was the element-substituted cordierite and the deeper portion was cordierite that was not element-substituted.

Next, Pt and Rh as the catalyst components were supported on the resulting ceramic support in the same way as in Example 1 to give a ceramic catalyst body. Purification performance of the resulting ceramic catalyst body was similarly evaluated. As a result, it was found that the ceramic catalyst body of Example 5 had an initial 50% purification temperature of 186° C. that was equivalent to the initial 50% purification temperature (180° C.) of Comparative Example 1 described above, but its 50% purification temperature after thermal durability was 293° C. and was lower by 104° C. than the 50% purification temperature (397° C) after thermal durability in Comparative Example 1. This was because the bonding strength between the replacing element and the catalyst component was higher in the product of the invention than the bonding strength between the lattice defect and the catalyst component in the Comparative product and the grain growth of the catalyst component due to thermal durability could be suppressed.

When the coefficient of thermal expansion of the ceramic support of Example 5 was measured, it was 0.45×10⁻⁶/° C., and was substantially equivalent to the coefficient of thermal expansion (0.40×10⁻⁶/° C.) of a ceramic support produced by using the same cordierite materials as those of Example 1 but not conducting element substitution by W.

### 5) Ion Coating of Replacing Element on Dried Body (Replacing Element: Pt)

Talc, kaolin, alumina and aluminum hydroxide were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm, was dried and was then fired at 1,390° C. in the atmosphere to give a fired body of the cordierite honeycomb structure. Next, the fired honeycomb structure was immersed in an aqueous platinic chloride solution dissolving platinum (Pt) as the replacing element in a concentration of 0.01 mol/L for 30 seconds. After excess solution was removed, the honeycomb structure was dried and was then fired at 1,390° C. in an atmosphere to obtain a ceramic support only the outermost surface layer portion of which had the element capable of directly supporting the catalyst component (Example 6).

Next, Pt and Rh as the catalyst components were supported on the resulting ceramic support in the same way as in Example 1 to give a ceramic catalyst body. Purification performance of the resulting ceramic catalyst body was similarly evaluated. As a result, it was found that the ceramic catalyst body of Example 6 had an initial 50% purification temperature of 188° C. that was equivalent to the initial 50% purification temperature (180° C.) of Comparative Example 1 described above, but its 50% purification temperature after thermal durability was 263° C. and was lower by 134° C. than the 50% purification temperature (397° C.) after thermal durability in Comparative Example 1. This was because the replacing element of the product of the invention had catalyst capability, the bonding strength between the replacing element and the catalyst component was great and the grain growth of the catalyst component due to thermal durability could be suppressed.

Purification performance of the resulting ceramic support was evaluated without supporting Pt and Rh as the catalyst components. As a result, it was confirmed that the initial 50% purification temperature was 350° C. and the 50% purification temperature after thermal durability was 352° C. and these value hardly underwent degradation. When the coefficient of thermal expansion of the ceramic support of Example 6 was measured, it was 0.47×10⁻⁶/° C., and the rise was limited to 0.07×10⁻⁶/° C. with respect to the thermal expansion (0.40×10⁻⁶/° C.) of a ceramic support produced by using the same cordierite materials as those of Example 1 but not conducting element substitution by W.

### 6) Supporting of Catalyst on Surface from Which Pores Were Removed (Replacing Element: W)

A ceramic support only the outermost surface portion of which was subjected to element substitution was produced in the same way as in Example 1. Next, the ceramic support was immersed in the 5 wt % aqueous solution of the binder used for shaping the honeycomb, and vacuum de-foaming was conducted for 5 minutes. After the excessive aqueous binder solution was removed, the ceramic support was dried. The dried support was then immersed in an ethanol solution dissolving 0.035 mol/L of platinic chloride and 0.025 mol/L of rhodium chloride for 5 seconds. After the excessive solution was removed, the ceramic support was dried and was fired at 600° C. in the atmosphere to metallize Pt and Rh (Example 7).

When the catalyst supporting condition of the resulting ceramic catalyst body was examined, it was confirmed that Pt and Rh as the catalyst components were supported on only the surface other than the pores. Incidentally, it was confirmed that Pt and Rh as the catalyst components were supported on the entire surface inclusive of the pores in all of Examples 1 to 6.

### 7) Formation of Support Layer on Surface of Substrate Layer (Replacing Elements: W and Ti)

A substrate layer of a support used cordierite as a main component. Talc, kaolin, alumina and aluminum hydroxide were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 103 mm, was dried and was then fired at 1,400 to 1,420° C. in the atmosphere to give the substrate layer.

Next, to form the support layer capable of directly supporting the catalyst components, talc, kaolin, alumina, aluminum hydroxide, and tungsten oxide (WO₃) and titania (TiO₂) as the compounds of the replacing elements were used as cordierite materials, and were prepared so that the composition became approximate to a theoretical composition point of cordierite. After suitable amounts of a binder, a lubricant, a humactant and moisture were added to the starting materials, the mixture was kneaded and converted to clay. The resulting clay was shaped into a honeycomb structure having a cell wall thickness of 100 μm, a cell density of 400 cpsi and a diameter of 50 mm, was dried and was then fired at 1,260° C. in the atmosphere to give a ceramic body capable of directly supporting the catalyst components by the replacing elements (W and Ti) through element substitution. This ceramic body was pulverized into powder and the powder was mixed with the binder. The mixture was coated to the surface of the substrate layer previously produced, and was fired, at 500 to 900° C., to form a support layer capable of directly supporting the catalyst components.

To support Pt and Rh as the main catalyst components on the ceramic support so obtained, an ethanol solution dissolving 0.035 mol/L of platinic chloride and 0.025 mol/L of rhodium chloride was prepared. The ceramic support was immersed in this solution for 5 minutes. After the excessive solution was removed, the ceramic support was dried and was fired at 600° C. in the atmosphere to metallize Pt and Rh. To further support the assistant catalyst components, the ceramic support was immersed in a slurry prepared by dissolving 400 g of CeO₂ powder and 4 g of alumina sol as an inorganic binder in 1 L of water for 1 minute. After the excessive slurry was removed, the ceramic support was dried and was then fired at 900° C. in the atmosphere to give a ceramic catalyst body (Example 8).

To evaluate purification performance of the ceramic catalyst body so obtained, a model gas containing C₃H₆ was introduced, and a 50% purification temperature of C₃H₆ was measured under the same condition as that of Example 1. Evaluation was made in the initial stage and after thermal durability (atmosphere, 1,000° C. for 24 hours), respectively. As a result, it was found that the ceramic catalyst body of Example 8 had an initial 50% purification temperature of 210° C. and a 50% purification temperature after thermal durability of 290° C., and had higher thermal degradation resistance than the ceramic catalyst body of Comparative Example 1 in which the coating layer of γ-alumina was formed on the surface of the cordierite honeycomb structure (initial 50% purification temperature of 180° C. and 50% purification temperature after thermal durability of 397° C.).

It was thus confirmed that the product of the invention had high bonding strength between the replacing elements and the catalyst components and had a higher effect of suppressing the grain growth of the catalyst components due to thermal durability than the Comparative product in which the coating layer of γ-alumina was formed on the surface of the cordierite honeycomb structure.

As described above, the invention uses the support capable of directly supporting the catalyst components by subjecting only the outermost surface layer portion of the substrate ceramic to element substitution, or the support prepared by coating the ceramic material capable of directly supporting the catalyst components through element substitution on the surface of the substrate layer of the ceramic, or the like, and can therefore provide a catalyst body having higher bonding strength with the catalyst components, than the prior art products, and being excellent in thermal durability and in mechanical and thermal characteristics.

What is claimed is:

1. A support having at least one kind of fine pores and elements each capable of directly supporting catalyst components on a surface of a substrate ceramic, wherein said fine pores and said elements each capable of directly supporting said catalyst components exist at only an outermost surface layer portion of said substrate ceramic.

2. A support according to claim 1, wherein said outermost surface layer portion of said substrate ceramic at which said fine pores or said elements exist has a depth corresponding to not greater than 1,000 unit crystal lattices of the ceramic.

3. A support according to claim 1, wherein said outermost surface layer portion of said substrate ceramic at which said fine pores or said elements exist has a depth corresponding to not greater than 200 unit crystal lattices of the ceramic.

4. A support according to claim 1, wherein said fine pores comprise at least one kind of members selected from the group consisting of defect in a ceramic crystal lattice, fine cracks on a surface of said ceramic and defects of elements constituting said ceramic.

5. A support according to claim 4, wherein said fine crack has a width of 100 nm or below.

6. A support according to claim 4, wherein said fine pores have a diameter or width 1,000 times or below the diameter of a catalyst ion to be supported, and the number of said fine pores is at least 1×10¹¹/L.

7. A support according to claim 4, wherein said pores are defects formed by replacing one or more kinds of constituent elements of said substrate ceramic by a replacing element or elements other than said constituent elements, and said defect can directly support said catalyst components.

8. A support according to claim 1, wherein said element is a replacing element introduced by replacing one or more kinds of constituent elements of said substrate ceramic by an element or elements other than said constituent elements, and said replacing element or elements can directly support said catalyst component.

9. A support according to claim 8, wherein said catalyst component is supported on said replacing element through chemical bonding.

10. A support according to claim 8, wherein said replacing element is one or more kinds of elements having a d or f orbit in an electron orbit thereof.

11. A support according to claim 1, wherein said substrate ceramic contains, as its main component, cordierite, alumina, spinel, mullite, aluminum titanate, zirconium phosphate, silicon carbide, silicon nitride, zeolite, perovskite or silica-alumina.

12. A support comprising a substrate layer and a support layer formed on a surface of said substrate layer, wherein said support layer comprises a ceramic having at least one kinds of fine pores and elements each capable of directly supporting a catalyst component on a substrate ceramic surface.

13. A support according to claim 12, wherein said substrate layer is formed of a ceramic or a metal.

14. A support according to claim 12, wherein said substrate layer has higher mechanical and thermal characteristics than said ceramic constituting said support layer.

15. A support according to claim 12, wherein said fine pores comprise at least one kind of members selected from the group consisting of defect in a ceramic crystal lattice, fine cracks on a surface of said ceramic and defects of elements constituting said ceramic.

16. A support according to claim 15, wherein said fine cracks have a width of 100 nm or below.

17. A support according to claim 15, wherein said fine pores have a diameter or width 1,000 times or below the diameter of a catalyst ion to be supported, and the number of said fine pores is at least 1×10¹¹/L.

18. A support according to claim 15, wherein said pores are defects formed by replacing one or more kinds of constituent elements of said substrate ceramic by a replacing element or elements other than said constituent elements, and said defect can directly support said catalyst components.

19. A support according to claim 12, wherein said element is a replacing element introduced by replacing one or more kinds of constituent elements of said substrate ceramic by an element or elements other than said constituent elements, and said replacing element or elements can directly support said catalyst component.

20. A support according to claim 19, wherein said catalyst component is supported on said replacing element through chemical bonding.

21. A support according to claim 19, wherein said replacing element is one or more kinds of elements having a d or f orbit in an electron orbit thereof.

22. A support according to claim 12, wherein said substrate ceramic contains, as its main component, cordierite, alumina, spinel, mullite, aluminum titanate, zirconium phosphate, silicon carbide, silicon nitride, zeolite, perovskite or silica-alumina.

23. A method of producing a support having an element capable of directly supporting a catalyst component at an outermost surface layer portion of a substrate ceramic, said element being a replacing element introduced by replacing one or more kinds of constituent elements of said substrate ceramic by an element or elements other than said constituent elements, said method comprising the steps of:
molding starting materials of said substrate ceramic;
forming a layer containing said replacing elements ionized on a surface of the resulting molding; and
firing said molding and at the same time, bonding said replacing element with said substrate ceramic.

24. A method of producing a support according to claim 23, wherein a solution dissolving said replacing element or a salt of said replacing element is coated to form a layer containing said replacing element.

25. A method of producing a support according to claim 23, wherein said substrate ceramic contains, as its main component, cordierite, alumina, spinel, mullite, aluminum titanate, zirconium phosphate, silicon carbide, silicon nitride, zeolite, perovskite or silica-alumina.

26. A method of producing a support having an element capable of directly supporting a catalyst component at an outermost surface layer portion of a substrate ceramic, said element being a replacing element introduced by replacing one or more kinds of constituent elements of said substrate ceramic by an element or elements other than said constituent elements, said method comprising the steps of:
molding and firing starting materials of said substrate ceramic;
removing a part of said ceramic constituent elements of an outermost surface layer portion of the resulting fired body;
forming a layer containing said replacing elements ionized on a surface of said outermost surface layer portion from which a part of said constituent elements is removed; and
bonding said replacing element with said substrate ceramic.

27. A method of producing a support according to claim 26, wherein a solution dissolving said replacing element or a salt of said replacing element is coated to form said layer containing said replacing element.

28. A method of producing a support according to claim 26, wherein a part of said ceramic constituent elements is removed by conducting wet etching, dry etching or sputter-etching.

29. A method of producing a support according to claim 26, wherein heat treatment is carried out to bond said replacing element with said substrate ceramic.

30. A method of producing a support according to claim 26, wherein said substrate ceramic contains, as its main component, cordierite, alumina, spinel, mullite, aluminum titanate, zirconium phosphate, silicon carbide, silicon nitride, zeolite, perovskite or silica-alumina.

31. A catalyst body obtained by directly supporting catalyst components on said support according to claim 1.

32. A catalyst body obtained by directly supporting catalyst components on said support according to claim 12.
